(19) United States
(12) Patent Application Publication
(10) Pub. No.: US 2010/0166316 A1
(43) Pub. Date: Jul. 1, 2010

(54) METHOD AND APPARATUS FOR PROCESSING A DIGITAL IMAGE INCLUDING A FACE DETECTION FINCTION

(75) Inventors: Jun-kwon Choi, Suwon-si (KR); Min-su Kang, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/625,671

(22) Filed: Nov. 25, 2009

(30) Foreign Application Priority Data
Dec. 26, 2008 (KR) 10-2008-0134962

(51) Int. Cl. G06K 9/46; G06F 3/12

(52) U.S. Cl. 382/190; 358/1.15

(57) ABSTRACT

A digital image processing apparatus and method may detect faces from an input image, obtain face number information indicating a number of faces detected, and generate an image file including the input image together and the face number information. A number of copies of the image file to print may be automatically determined based on the face number information. A plurality of image files may also be arranged according to their respective number of detected faces.

### CROSS-REFERENCE TO RELATED PATENT APPLICATION

This application claims the priority benefit of Korean Patent Application No. 10-2008-0134962, filed on Dec. 26, 2008, in the Korean Intellectual Property Office, the disclosure of which is incorporated herein in its entirety by reference.

### BACKGROUND

1. Field of the Invention

The present invention relates to a digital image processing method and apparatus, and more particularly to a digital image processing method and apparatus which detects a number of faces in an image for storing, arranging, or printing image files according to the detected number of faces.

2. Description of the Related Art

Various types of electronic devices have a face detection function. Through the face detection function, a region considered as a face is typically detected from an input image. The face detection function may be performed according to various algorithms, such as face detection using facial colors, face detection using movement, and neural network analysis based on statistical cluster information. Also, the Adaboost algorithm is an example of a face detection algorithm.

The face detection function has been used in the field of digital photographing apparatuses, which are a type of digital image processing apparatus. Using the face detection function, the digital photographing apparatus may detect a region considered as a face and perform automatic focusing on the region, thereby increasing the convenience of those who are not accustomed to handling the digital photographing apparatus.

Also, the face detection function may be used in image processing apparatuses. For example, an image processing apparatus may use the face detection function in order to detect a face and correct facial colors.

### SUMMARY

An exemplary digital image processing method and apparatus may detect faces from an input image so that the input image may be stored together with face number information indicating a number of faces detected.

Another exemplary digital image processing method and apparatus may automatically determine a number of copies of an image file to be printed based on face number information stored together with the image file when the image file is printed.

An exemplary digital image processing method and apparatus may arrange a plurality of image files according to a number of faces indicated in face number information of the respective image files.

An exemplary digital image processing method may include detecting faces from an input image, obtaining face number information indicating a number of faces detected, and generating an image file including the input image and the face number information. The digital image processing method may further include storing the image file on a storage medium.

Generating the image file may include recording the face number information in a header section of the image file.

Detecting faces from the input image may include detecting faces from a live-view image. Alternatively, detecting faces from the input image may include detecting faces from a captured image.

The digital image processing method may further include receiving a signal representing a request to print the image file, determining a number of copies of the image file to print according to the number of faces indicated by the face number information, and controlling printing of the image file such that the determined number of copies of the image file are printed.

The digital image processing method may further include arranging a plurality of image files according to their respective face number information.

An exemplary digital image processing apparatus for processing a digital image may include a face detection unit configured to detect faces from an input image, a face number information obtaining unit communicatively coupled with the face detection unit and configured to obtain face number information indicating a number of faces detected, and an image file generation unit generating communicatively coupled with the face number information obtaining unit and configured to generate an image file including the input image and the face number information. The image file generation unit may be further configured to record the face number information in a header section of the image file.

The face detection unit may be further configured to detect faces from a live-view image. Alternatively, the face detection unit may be further configured to detect faces from a captured image.

The digital image processing apparatus may further include a printing controller configured to receive a signal representing a request to print the image file and in response thereto, determine a number of copies of the image file to print according to the number of faces indicated in the face number information. The printing controller may be further configured to control the printing of the image file such that the determined number of copies of the image file are printed.

The digital image processing apparatus may further include an image file storage unit communicatively coupled with the image file generation unit and configured to store a plurality of image files, each of the plurality of image files including the respective face number information. The digital image processing apparatus may further include a digital content management unit communicatively coupled with the image file storage unit, the digital content management unit configured to arrange the plurality of image files according to the respective face number information.

A computer-readable storage medium may have stored thereon a program, the program being executable by a processor to perform a digital image processing method, the method including detecting faces from an input image, obtaining face number information indicating a number of faces detected, and generating an image file including the input image and the face number information. The method may further include determining a number of copies of the image file to print according to the number of faces indicated by the face number information, in response to a signal representing a request to print the image file.

An exemplary method of controlling an electronic device may include receiving a signal representing a request to print an image file, and determining whether the image file includes face number information indicating a number of faces included in an image. When the image file includes the face number information, the method may include determining a number of copies of the image file to print according to the number of faces indicated in the face number information. Alternatively, when the image file does not include the face number information, the method may include determining the number of copies of the image file to print to be a predetermined value. The method may further include controlling printing of the image file such that the determined number of copies of the image file are printed.

An exemplary electronic device may include an image file storage unit configured to store one or more image files, each of the image files including face number information indicating a number of faces included in an image. The electronic device may also include a printing controller configured to determine a number of copies of an image file to be printed according to a number of the faces indicated in the face number information when at least one of the one or more image files includes the face number information, in response to a signal representing a request to print the one or more image files.

An exemplary method of controlling an electronic device may include receiving a signal representing a request to arrange a plurality of image files according to their respective face number information, determining whether each of the plurality of image files includes face number information indicating a number of faces included in an image, and arranging the plurality of image files including the face number information according to their respective face number information. Arranging the plurality of image files may include changing at least one of filenames or logical file locations of the plurality of image files on a storage medium.

An exemplary electronic device may include an image file storage unit configured to store one or more image files, each of the image files including face number information indicating a number of faces in an image. The electronic device may also include a digital content management unit configured to arrange a plurality of image files based on their respective face number information, in response to a signal representing a request to arrange the plurality of image files according to their respective face number information.

### BRIEF DESCRIPTION OF THE DRAWINGS

The above and other features and advantages of the present invention will become more apparent by describing in detail exemplary embodiments thereof with reference to the attached drawings listed below:

FIG. 1 is a block diagram of an exemplary digital image processing apparatus.

FIG. 2 is a view of face regions detected from an input image and displayed in an exemplary digital image processing apparatus.

FIG. 3 is a flowchart illustrating an exemplary method of processing a digital image.

FIG. 4 is a conceptual diagram schematically illustrating a construction of an image file generated by an exemplary digital image processing apparatus.

FIG. 5 is a block diagram of an exemplary digital image processing apparatus.

FIG. 6 is a block diagram of an exemplary electronic device and a printing device that can communicate with the electronic device.

FIG. 7 is a flowchart illustrating an exemplary method of controlling an electronic device.

FIG. 8A is a block diagram of another exemplary electronic device.

FIG. 8B is a block diagram of another exemplary electronic device that is a modification of the electronic device of FIG. 8A.

FIG. 9 is a flowchart illustrating an exemplary method of controlling an electronic device.

FIG. 10 is a block diagram of another exemplary electronic device.

FIG. 11 is a block diagram of an exemplary digital image processing apparatus.

### DETAILED DESCRIPTION

Hereinafter, exemplary embodiments of the present invention will be described in greater detail with reference to the accompanying drawings. Descriptions of these embodiments are provided so that this disclosure may be thorough and complete and will fully convey the concept of the invention to those of ordinary skill in the art. In the following description, well-known functions or constructions may not be described in detail if by doing so, the description would obscure understanding of the invention due to unnecessary detail.

The disclosure and drawings included herein are not intended to restrict the scope of the present invention and are only used to facilitate the understanding of the present invention. The specific terms used in this disclosure should be interpreted as having a meaning that is consistent with their meaning in the context of the relevant art and should not be interpreted in an idealized or overly formal sense unless expressly so defined herein.

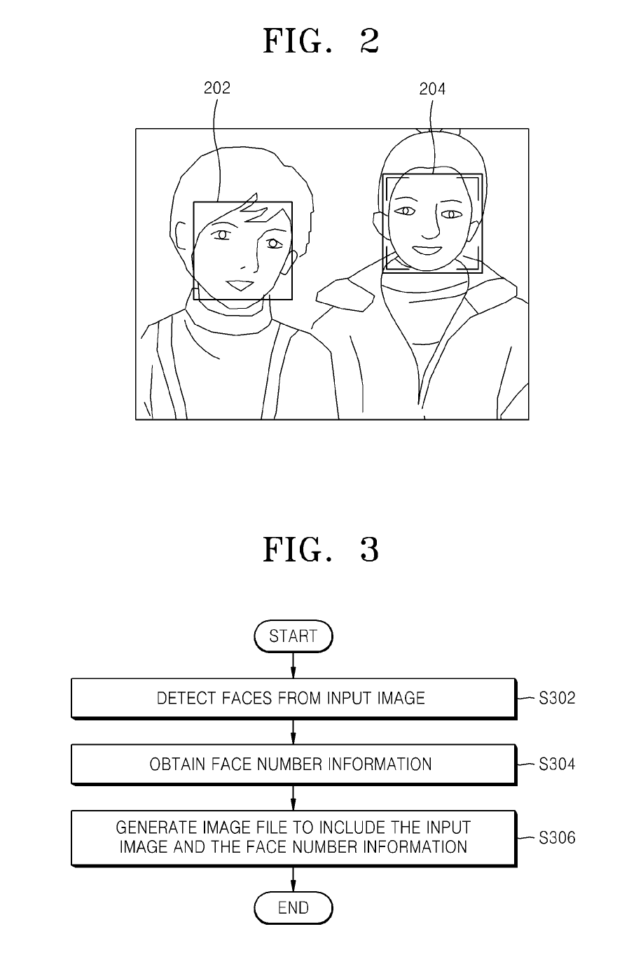

The present invention relates to a digital image processing apparatus and method for detecting faces from an input image and storing the input image accompanied by the total number of detected faces in an image file. Recently, various digital photographing apparatuses having a face detection function have been introduced in the market. Referring to FIG. 2, a digital image processing apparatus may display regions 202 and 204, which may be detected as faces, and then, the digital image processing apparatus may focus on one of the regions 202 and 204, for example, the region 204. However, even if a plurality of face regions are detected from the input image, only one face region from among the face regions may be focused on. Thus, the other detected face regions typically cannot be used for focusing. Accordingly, when a plurality of face regions are detected from an input image, the total number of detected face regions may be stored as face number information together with the input image in an image file such that the face number information may be used beneficially.

Furthermore, the present invention relates to an electronic device that may use the face number information and a method of controlling the electronic device. The face number information stored when photographing may be used in various manners. In particular, an exemplary electronic device and method of controlling the electronic device may determine a number of copies of an image file to printing by using the face number information associated with the image file. Another exemplary electronic device and method of controlling the electronic device may arrange a plurality of image files based on a number of faces indicated in the face number information in each of the plurality of image files.

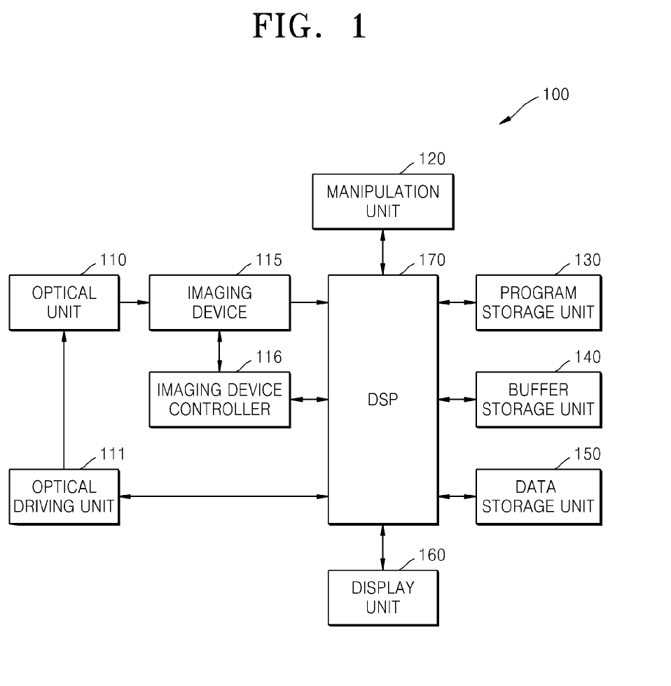

FIG. 1 is a block diagram of an exemplary digital image processing apparatus 100. The exemplary digital image processing apparatus 100 may include an optical unit 110, an optical driving unit 111, an imaging device 115, an imaging device controller 116, a manipulation unit 120, a program storage unit 130, a buffer storage unit 140, a data storage unit 150, a display unit 160, and a digital signal processor (DSP) 170. The exemplary digital image processing apparatus 100 having such a construction may operate as a digital photographing apparatus.

The optical unit 110 may provide an optical signal of a subject to the imaging device 115. The optical unit 110 may include at least one of a zoom lens for controlling a viewing angle to be widened or narrowed according to focal length, and a focus lens that focuses on a subject. The optical unit 110 may further include an aperture for controlling an amount of light in the optical signal provided to the imaging device 115.

The optical driving unit 111 may control the position of a lens or the closing or opening of the aperture in the optical unit 110. The optical driving unit 111 may control focusing by changing the position of the focus lens, and may control the amount of light passing through the optical unit 110 by adjusting a degree of closing or opening of the aperture in the optical unit 110. The optical driving unit 111 may control the optical unit 110 in response to a control signal that is automatically generated corresponding to an image signal input in real time or that is manually input by a user.

The optical signal provided by the optical unit 110 may be incident on a light-receiving surface of the imaging device 115 and may form an image of the subject thereon. The imaging device 115 may employ a charge-coupled device (CCD) or a complementary metal oxide semiconductor image sensor (CIS) that transforms an optical signal into an electrical signal. The sensitivity of the imaging device 115 may be controlled by the imaging device controller 116. The imaging device controller 116 may control the imaging device 115 in response to a control signal that is automatically generated corresponding to an image signal input in real time or that is manually input by a user.

The control signal may be input from outside the digital image processing apparatus 100, e.g., by a user, via the manipulation unit 120. Although not shown, the manipulation unit 120 may include various function buttons, e.g., a shutter-release button via which a shutter-release signal may be input to perform photographing by exposing the imaging device 115 to light for a predetermined length of time; a power button for supplying power to the digital image processing apparatus 100; a wide angle-zoom button and a telephoto-zoom button for widening or narrowing a viewing angle; a mode selection button for selecting a mode, such as a character input mode, a shooting mode, and a playback mode; a white balance control button; and an exposure control button. However, the manipulation unit 120 is not limited to having the various function buttons listed above and may be constructed in various ways. For example, the manipulation unit 120 may include a keyboard, a touch pad, a touch screen, a mode dial, or a remote controller via which user input may be received.

The exemplary digital image processing apparatus 100 may further include a program storage unit 130 that stores an operating system for driving, for example, a digital camera, and a program of the operating system; a buffer storage unit 140 that temporarily stores data necessary for performing an operation or resultant data; and a data storage unit 150 that stores an image file including an image signal and various information necessary for running the program.

The exemplary digital image processing apparatus 100 may also include the display unit 160 that may display an operating state of the exemplary digital image processing apparatus 100 or information regarding an image captured by the digital image processing apparatus 100. The display unit 160 may provide a user with visual and/or acoustic information. For example, in order to provide visual information, the display unit 160 may include a liquid crystal display (LCD), an organic light emitting diode (OLED) display, or an electronic digital display. To provide the user with acoustic information, the display 160 may include a speaker.

The exemplary digital image processing apparatus 100 may also include the digital signal processor 170 that may process a received image signal and control the other elements of the exemplary digital image processing apparatus 100 according to the processing result or an external input signal.

FIG. 2 is a view of face regions detected from an input image and displayed in an exemplary digital image processing apparatus, such as the exemplary digital image processing apparatus 100. The digital image processing apparatus 100 may be capable of detecting the face regions 202 and 204 from an input image and display them as illustrated in FIG. 2. In this case, the exemplary digital image processing apparatus 100 may functions as a digital photographing apparatus and thus may be capable of auto-focusing on one of the face regions 202 and 204.

FIG. 3 is a flowchart illustrating an exemplary method of processing a digital image. In the method, when an input image is received, a region considered as a face may be detected from the input image (operation S302). Various face detection algorithms may be used to detect a face. For example, the Adaboost algorithm may be used. In an embodiment, when the method of processing a digital image is performed in a digital photographing apparatus, face detection may be performed on a live-view image.

If faces are detected from the input image, face number information indicating the total number of faces detected from the input image may be obtained (operation S304). In an embodiment, when the method of processing a digital image is performed in a digital photographing apparatus, the face number information may be obtained simultaneously with or after capturing a live-view image.

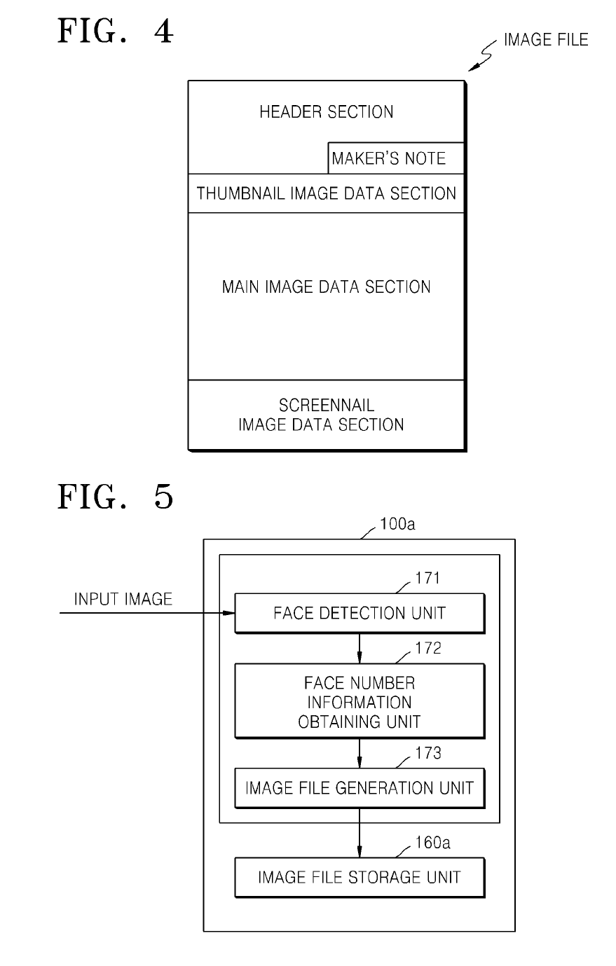

Next, an image file may be generated including the input image and the face number information (operation S306). In an embodiment, when the method of processing a digital image is performed in a digital photographing apparatus, the input image included in the image file may be captured from a live-view image in response to a shutter-release signal. The input image may be appropriately transformed and compressed. For example, the input image may be compressed according to the Joint Photographic Experts Group (JPEG) standards. The construction of the image file generated according to the method of processing a digital image will now be described in detail with reference to FIG. 4.

FIG. 4 is a conceptual diagram schematically illustrating a construction of an image file generated by an exemplary digital image processing apparatus. Referring to FIG. 4, the image file may include a header section, a thumbnail image data section, a main image data section, and a screennail image data section. However, the construction of the image file is not limited to the one illustrated in FIG. 4 and the image file may be constructed in various ways.

The main image data section may include image data.

The header section may include data regarding the manufacturing company and model name of the digital image processing apparatus. When the digital image processing apparatus includes a digital photographing apparatus, the header section may include data such as a shooting time, a shutter speed, an aperture value, or a zoom magnification.

The thumbnail image data section may include thumbnail image data, where a thumbnail image is a reduced-size version of a main image included in the main image data section. The thumbnail image data may be used to display a plurality of small images representative of main images (e.g., simultaneously or in rapid succession) during a search for an image file.

The screennail image data section may include image data that is used to reproduce an image file and display an image on a display unit of the digital image processing apparatus. In general, since the display unit 160 of the digital image processing apparatus 100, which may be a portable apparatus, may have a small size, the image data (i.e., the original image data) stored in the main image data section may not need to be displayed on the display unit 160. In particular, the size of data stored in the main image data section is generally far greater than that of data necessary for displaying a screennail image on the display unit 160. Thus, if the screennail image is displayed on the display unit 160 by using the data stored in the main image data section, it may not only take a large amount of time to process the data but also the quality of the screennail image displayed on the display unit 160 may be degraded. Thus, a reduced-size version of the screennail image may additionally be included in the image file so that the screennail image can be displayed on the display unit 160. Typically, image data having a resolution of 640×480 may be stored in the screennail image data section.

The header section of the image file may further include a maker's note. The maker's note may include a recording space on which the maker who uses the image file may record desired information. In the exemplary digital image processing apparatus and method, face number information may be stored in the recording space, such as in the maker's note.

FIG. 5 is a block diagram of an exemplary digital image processing apparatus 100a. The digital image processing apparatus 100a may include a face detection unit 171, a face number information obtaining unit 172, and an image file generation unit 173. These constitutional elements may be embodied with executable computer codes, which may be respectively programmed to perform the functions of these constitutional elements, in the DSP 170 of FIG. 1. The computer codes may be stored in the program storage unit 130 of FIG. 1.

The face detection unit 171 may detect a region considered as a face from an input image. The face detection unit 171 may use various face detection algorithms in order to detect a face. For example, the Adaboost algorithm may be used. In an embodiment, if the exemplary digital image processing apparatus 100 includes a digital photographing apparatus, the input image may be input to the imaging device 115 of FIG. 1, and more particularly, may be a live-view image input to the imaging device 115.

The face number information obtaining unit 172 may obtain face number information indicating a total number of faces detected by the face detection unit 171. The face number information may be stored in the face detection unit 171, or may be obtained by counting regions which are considered as faces and detected by the face detection unit 171, by using the face number information obtaining unit 172. In an embodiment, if the exemplary digital image processing apparatus 100 includes a digital photographing apparatus, the face number information may be obtained simultaneously with or after capturing a live-view image.

The image file generation unit 173 may generate an image file that includes the face number information and the input image. The image file generation unit 173 may appropriately transform and compress the input image. For example, the input image may be compressed according to the JPEG standards. The face number information may be included in a header section of the image file. In an embodiment, if the exemplary digital image processing apparatus 100 includes a digital photographing apparatus, the input image included in the image file may be captured from a live-view image. The image file generation unit 173 may store the image file in an image file storage unit 160a.

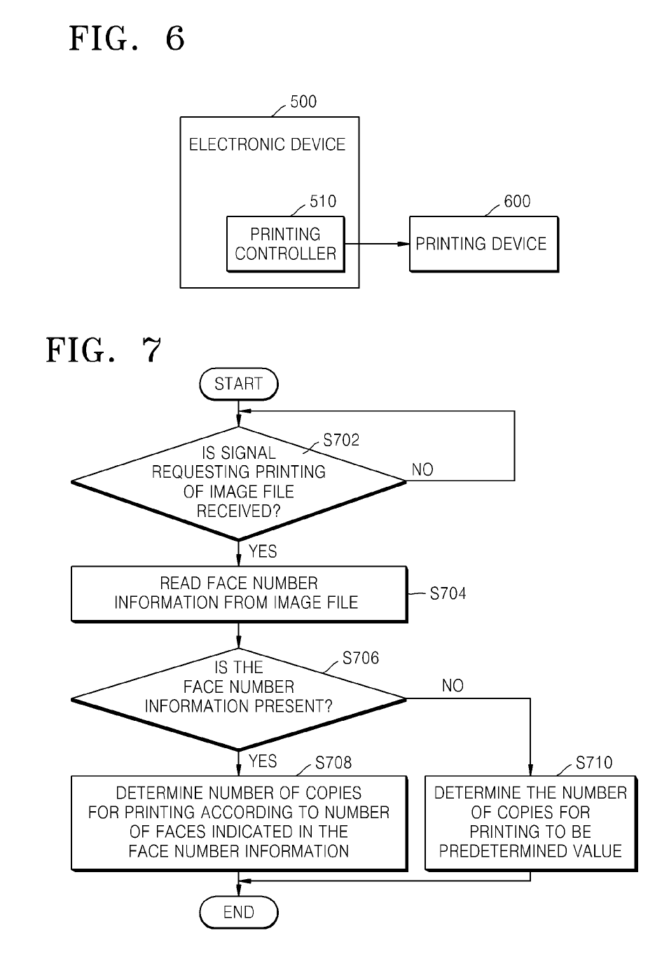

FIG. 6 is a block diagram of an exemplary electronic device 500 and a printing device 600 that can communicate with the electronic device 500. In the electronic device 500 and a method of controlling the electronic device 500 according to the current embodiment, when an image file is printed, a number of copies to be printed may be determined based on face number information included in the image file. As illustrated in FIG. 6, the electronic device 500 that stores at least one image file may function as a printing server that controls the printing function of the printing device 600. In the present embodiment, the electronic device 500 is separate from the printing device 600; however, the present invention is not limited thereto and thus the electronic device 500 may include the printing device 600. To this end, the electronic device 500 may include a printing controller 510 that controls the printing function of the printing device 600. In the electronic device 500 and the method of controlling the electronic device 500 according to the current embodiment, when an image file including face number information is printed, the printing device 600 may be controlled to determine the number of copies to print according to the total number of faces indicated in the face number information.

In general, since a user may determine a number of copies to print according to a number of faces captured when an image file is printed, it is possible to increase the user's convenience according to the current embodiment.

FIG. 7 is a flowchart illustrating an exemplary method of controlling an electronic device. In the method of controlling an electronic device, when a signal that represents a request to print an image file is received (e.g., from a printing device) (operation S702), face number information may be read from the image file (operation S704).

If the image file is determined to include the face number information (operation S706), the number of copies to print may be determined according to the total number of faces indicated in the face number information (operation S708). Otherwise, if the image file is determined to not include the face number information (operation S706), the number of copies for printing may be determined to be a predetermined value (operation S710). The determined number of copies may be changed according to user input.

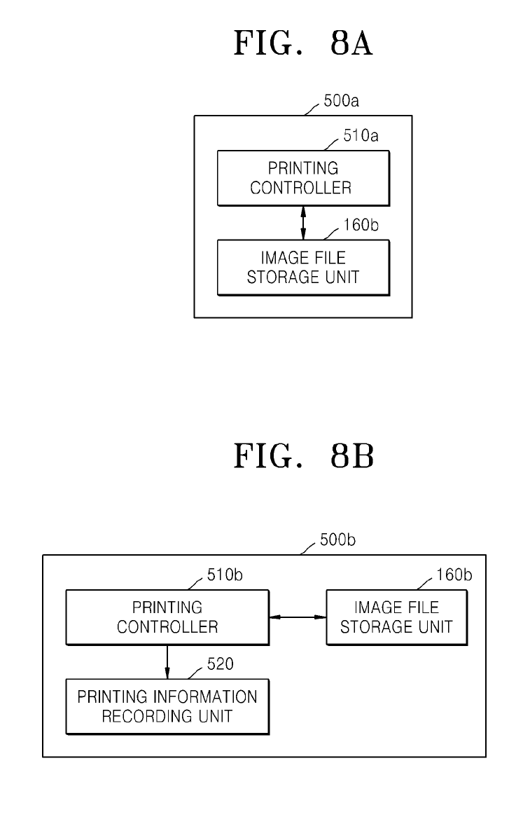

FIG. 8A is a block diagram of another exemplary electronic device 500a. Specifically, FIG. 8A illustrates the electronic device 500a that may be connected to the printing device 600 of FIG. 6 in order to establish communication with the printing device 600. The electronic device 500a may be connected to the printing device 600, which may be an external device, in order to establish communication with the printing device 600, and thus, may function as a printing server. Also, the electronic device 500a may directly control the operation of the printing device 600 when the printing device 600 is included in the electronic device 500a. For example, if the electronic device 500a includes a digital photographing apparatus, during a shooting operation, the digital photographing apparatus may generate an image file including face number information, store the image file in the image file storage unit 160b, read the image file from the image file storage unit 160b, and determine the number of copies to print according to a number of faces indicated in the face number information when the image file is printed.

Also, the electronic device 500a may include a printing controller 510a that reads an image file from the image file storage unit 160b and controls the printing device 600 to print the image file.

FIG. 8B is a block diagram of another exemplary electronic device 500b that is a modification of the electronic device 500a of FIG. 8A. The electronic device 500b may store printing information in a mobile storage medium. When the mobile storage medium is loaded into the printing device 600 of FIG. 6, which may be an external device, the printing device 600 may perform printing based on the stored printing information. Even if the electronic device 500b that has a printing control function is not connected to the printing device 600 in order to establish communication with the printing device 600, the electronic device 500b may be capable of storing the printing information in the mobile storage medium and delivering the printing information to the printing device 600 via the mobile storage medium in order to control the printing device 600. To this end, the electronic device 500b may include the image file storage unit 160b, a printing controller 510b, and a printing information recording unit 520. If a signal that represents a request to print an image file is input to the printing controller 510b, the printing controller 510b may read the image file from the image file storage unit 160b and generate printing control information, in response to the signal. When an image file that includes face number information is printed, the printing controller 510b may determine a number of copies to print according to a number of faces indicated in the face number information. The printing controller 510 b may include the image file and/or the determined number of copies of the image file to print in the printing control information. The printing information recording unit 520 may record the printing control information generated by the printing controller 510b in a storage medium (not shown). When the storage medium is loaded into the printing device 600, the printing device 600 may print the image file based on the stored printing control information.

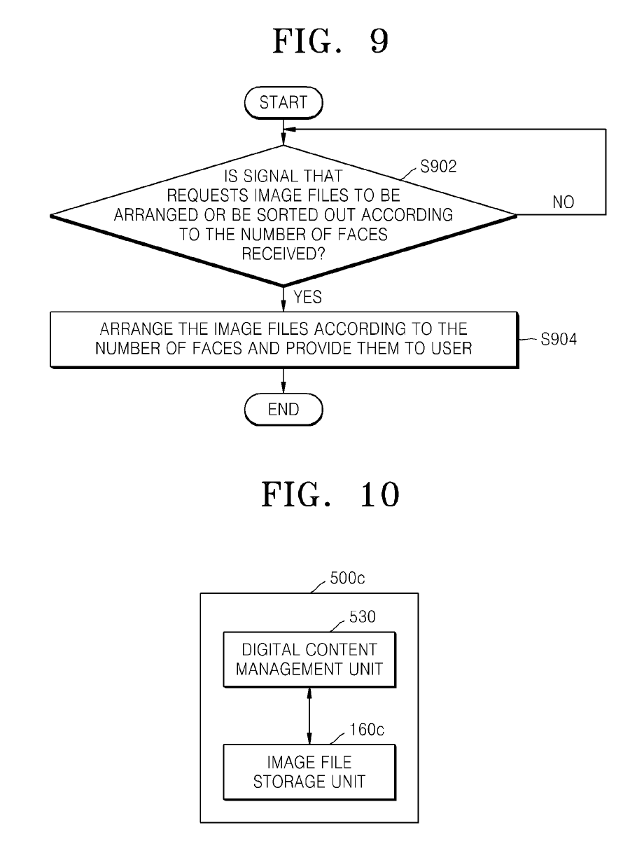

FIG. 9 is a flowchart illustrating an exemplary method of controlling an electronic device. In the current embodiment, the electronic device and the method of controlling the electronic device may be capable of managing a plurality of image files based on face number information. In the current embodiment, image files may be sorted out or arranged according to face number information included in the image files. For example, when a user desires to search for only photos containing one face, the electronic device 500b may detect image files that are recorded to include only one face in the face number information and provide the detected image files to the user.

Referring to FIG. 9, when a signal that represents a request to arrange or sort out image files according to the number of faces is received (operation S902), the image files may be arranged according to the number of faces and then may be provided to a user (operation S904).

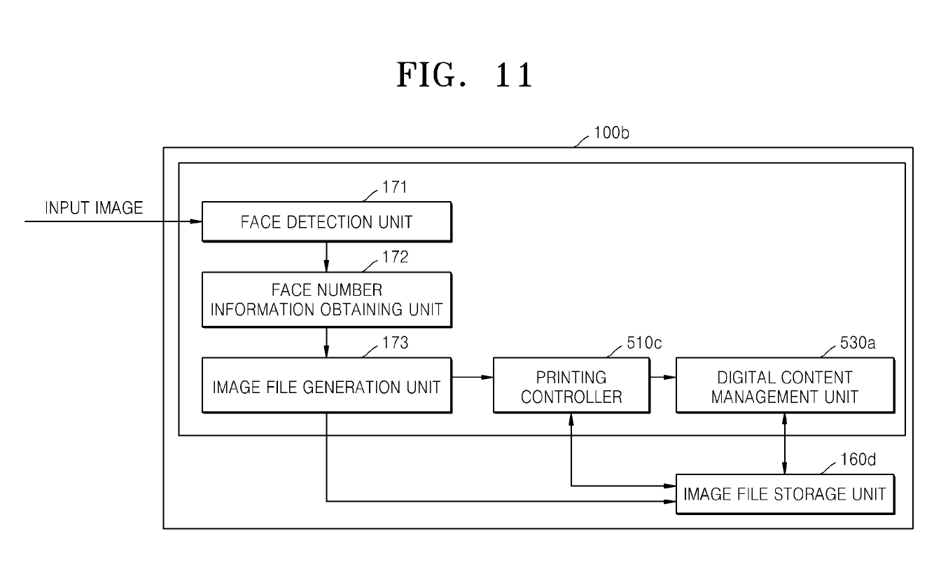

FIG. 10 is a block diagram of another exemplary electronic device 500c. The electronic device 500c may include a digital content management unit 530 that sorts out or arranges image files according to face number information, and an image file storage unit 160c that stores the image files. The digital content management unit 530 may read the image files from the image file storage unit 160c and sort out or arrange the image files according to face number information included in the image files, in response to a signal that represents a request to arrange the image files according to their respective number of faces. For example, if a user requests the image files to be arranged according to their respective face number information, the digital content management unit 530 may group image files that have the same face number information and provide the grouped image files to the user. The image files may be grouped by changing their filenames, by sorting them into different file folders in the image file storage unit 500c, or by providing the user with a filtered list of the grouped image files that does not include the image files having different face number information, for example.

FIG. 11 is a block diagram of an exemplary digital image processing apparatus 100b. Referring to FIG. 11, the digital image processing apparatus 100b may obtain face number information from an input image, generate an image file to include the input image together with the face number information, and store the image file in an image file storage unit 160d. The digital image processing apparatus 100b may further include a printing controller 510c and a digital content management unit 530a, compared to the digital image processing apparatus 100b of FIG. 5. When the image file stored in the image file storage unit 160d or an image file generated by the image file generation unit 173 is printed, the printing controller 510c may determine the number of copies to print based on face number information included in the image file. The digital content management unit 530a may sort out or arrange image files stored in the image file storage unit 160d according to the face number information. The operations of the above constitutional elements are as described above, and thus, a detailed description thereof will not be provided here.

According to the above embodiments of the present invention, an image file may be generated to include an image together with face number information indicating a number of faces detected in the image, the number of copies to be printed may be automatically determined based on the face number information, and a plurality of image files may be arranged according to their respective number of detected faces, thereby greatly improving a user's convenience.

Functional programs, codes, and code segments for accomplishing the present invention can be easily construed by programmers of ordinary skill in the art to which the present invention pertains. Embodiments of the present invention may be implemented as one or more software modules. These software modules may be stored as program instructions executable by a processor on a computer-readable storage medium, where the program instructions stored on this medium can be read by a computer, stored in a memory, and executed by the processor. For example, the software modules may include computer-readable code constructed to perform the operations included in a digital image processing method according to the present invention when this code is read from the computer-readable storage medium via the DSP 170 of FIG. 1. Examples of the storage medium include magnetic storage media (e.g., floppy disks, hard disks, or magnetic tape), optical recording media (e.g., CD-ROMs or digital versatile disks (DVDs)), and electronic storage media (e.g., integrated circuits (IC's), ROM, RAM, EEPROM, or flash memory). The storage medium may also be distributed over network-coupled computer systems so that the program instructions are stored and executed in a distributed fashion.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements, the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

It will be recognized that the terms “comprising,” “including,” and “having,” as used herein, are specifically intended to be read as open-ended terms of art. The use of the terms “a” and “and” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

What is claimed is:

1. A digital image processing method comprising:
detecting faces from an input image;
obtaining face number information indicating a number of faces detected; and
generating an image file including the input image and the face number information.

2. The method of claim 1, further comprising storing the image file on a storage medium.

3. The method of claim 1, wherein generating the image file comprises recording the face number information in a header section of the image file.

4. The method of claim 1, wherein detecting faces from the input image comprises detecting faces from a live-view image.

5. The method of claim 1, wherein detecting faces from the input image comprises detecting faces from a captured image.

6. The method of claim 1, further comprising
receiving a signal representing a request to print the image file,
determining a number of copies of the image file to print according to the number of faces indicated by the face number information, and
controlling printing of the image file such that the determined number of copies of the image file are printed.

7. The method of claim 1, further comprising arranging a plurality of image files according to their respective face number information.

8. A digital image processing apparatus for processing a digital image, the apparatus comprising:
a face detection unit configured to detect faces from an input image;
a face number information obtaining unit communicatively coupled with the face detection unit and configured to obtain face number information indicating a number of faces detected; and
an image file generation unit communicatively coupled with the face number information obtaining unit and configured to generate an image file including the input image and the face number information.

9. The apparatus of claim 8, wherein the image file generation unit is further configured to record the face number information in a header section of the image file.

10. The apparatus of claim 8, wherein the face detection unit is further configured to detect faces from a live-view image.

11. The apparatus of claim 8, wherein the face detection unit is further configured to detect faces from a captured image.

12. The apparatus of claim 8, further comprising a printing controller configured to receive a signal representing a request to print the image file and in response thereto, determine a number of copies of the image file to print according to the number of faces indicated in the face number information.

13. The apparatus of claim 12, wherein the printing controller is further configured to control the printing of the image file such that the determined number of copies of the image file are printed.

14. The apparatus of claim 8, further comprising an image file storage unit communicatively coupled with the image file generation unit and configured to store a plurality of image files, each of the plurality of image files including the respective face number information.

15. The apparatus of claim 14, further comprising a digital content management unit communicatively coupled with the image file storage unit, the digital content management unit configured to arrange the plurality of image files according to the respective face number information.

16. A computer-readable storage medium having stored thereon a program, the program being executable by a processor and comprising:
a code section for detecting faces from an input image;
a code section for obtaining face number information indicating a number of faces detected; and
a code section for generating an image file including the input image and the face number information.

17. The computer-readable storage medium of claim 16, wherein the code section for generating the image file comprises recording the face number information in a header section of the image file.

18. The computer-readable storage medium of claim 16, wherein the program further comprises a code section for determining a number of copies of the image file to print according to the number of faces indicated by the face number information, in response to a signal representing a request to print the image file.

19. The computer-readable storage medium of claim 16, wherein the method further comprises a code section for arranging a plurality of image files according to their respective face number information.

20. A method of controlling an electronic device, the method comprising:
receiving a signal representing a request to print an image file;
determining whether the image file includes face number information indicating a number of faces included in an image;
when the image file includes the face number information, determining a number of copies of the image file to print according to the number of faces indicated in the face number information;
when the image file does not include the face number information, determining a number of copies of the image file to print to be a predetermined value; and
controlling printing of the image file such that the determined number of copies of the image file are printed.

21. A method of controlling an electronic device, the method comprising:
receiving a signal representing a request to arrange a plurality of image files according to their respective face number information;
determining whether each of the plurality of image files includes face number information indicating a number of faces included in an image; and
arranging the plurality of image files including the face number information according to their respective face number information.

22. The method of claim 21, wherein arranging the plurality of image files comprises changing at least one of filenames or logical file locations of the plurality of image files on a storage medium.
